(19) United States
(12) Patent Application Publication
(10) Pub. No.: US 2012/0264019 A1
(43) Pub. Date: Oct. 18, 2012

(54) ELECTRODE ACTIVE MATERIAL, ELECTRODE, AND SODIUM SECONDARY BATTERY

(75) Inventor: Maiko Saka, Tsukuba-shi (JP)

(73) Assignee: SUMITOMO CHEMICAL COMPANY, LIMITED, Chuo-ku, Tokyo (JP)

(21) Appl. No.: 13/517,140

(22) PCT Filed: Dec. 15, 2010
(86) PCT No.: PCT/JP2010/073067

§ 371 Date: Jun. 19, 2012

(30) Foreign Application Priority Data
Dec. 24, 2009 (JP) 2009-292268

(51) Int. Cl. H01M 4/485; H01M 4/505; H01M 4/525

(52) U.S. Cl. 429/221; 429/231.1; 429/224

(57) ABSTRACT

The present invention provides an electrode active material, an electrode and a sodium secondary battery. The electrode active material contains the following powder (A) and powder (B):
(A) a powder of a transition metal sodium phosphate, the powder having a BET specific surface area of from 1 m²/g to 100 m²/g,
(B) a powder of a mixed metal oxide or a powder of a transition metal lithium phosphate or both. The electrode has the electrode active material. The non-aqueous electrolyte secondary battery has the electrode as a positive electrode.

### TECHNICAL FIELD

The present invention relates to an electrode active material, and more particularly to an electrode active material usable for a sodium secondary battery.

### BACKGROUND ART

A lithium secondary battery has already been put into practical use as a power supply for use in small-sized apparatuses such as portable telephones and notebook personal computers. There have been increasing demands for a secondary battery as a power supply for use in large-sized apparatuses such as electric automobiles and dispersion-type power storages.

Lithium for use in electrodes of a lithium secondary battery is not considered to be abundant in resources. On the other hand, sodium, which belongs to the same alkali metal element as lithium, is abundant in resources, and since sodium has a comparatively high standard electric potential, if a sodium secondary battery using sodium can be utilized in place of a current lithium secondary battery, it becomes possible to produce a large-number of large-sized secondary batteries, such as secondary batteries for use in automobiles and secondary batteries for use in dispersion-type power storages, with suppressing a concern of drying up of the resources.

As an electrode active material for use in a sodium secondary battery, for example, Patent Document 1 has disclosed that materials are mixed and then calcined at 750° C. for 8 hours to obtain sodium iron phosphate (NaFePO₄) and this is used as a positive electrode.

### PRIOR ART DOCUMENT

### Patent Document

[Patent Document 1]: JP2004-533706A

### SUMMARY OF THE INVENTION

Even when a transition metal sodium phosphate in accordance with the prior art as disclosed in Patent Document 1 is used for an electrode of a sodium secondary battery, the resultant battery is not sufficient from the viewpoint of discharging capacity. An object of the present invention is to provide an electrode active material that achieves a sodium secondary battery having high capacity.

The present invention provides the following means:

<1> An electrode active material comprising the following powder (A) and powder (B):
(A) a powder of a transition metal sodium phosphate, the powder having a BET specific surface area of from 1 m²/g to 100 m²/g,
(B) a powder of a mixed metal oxide or a powder of a transition metal lithium phosphate or both.
<2> The electrode active material according to <1>, wherein the content of the powder (A) is from 10 parts by weight to 900 parts by weight relative to 100 parts by weight of the powder (B).
<3> The electrode active material according to <1> or <2>, wherein the transition metal sodium phosphate in the powder (A) is represented by the following formula (1):

Naₓ₁M¹_{y1} (PO₄)_{z1} (1)

wherein M¹ represents one or more elements selected from the group consisting of transition metal elements, 0<x₁≦1.5, 0<y₁≦3 and 0<z₁≧3.
<4> The electrode active material according to <3>, wherein M¹ comprises a divalent transition metal element.
<5> The electrode active material according to <3> or <4>, wherein M¹ comprises Fe or Mn or both.
<6> The electrode active material according to any one of <1> to <5>, wherein the mixed metal oxide in the powder (B) is represented by the following formula (2):

A¹ₓ₂M²_{y2}O_{z2} (2)

wherein A¹ represents one or more elements selected from the group consisting of Li, Na and K, M² represents one or more elements selected from the group consisting of transition elements, 0<x₂≦1.5, 0<y₂≦3 and 0<z₂≦6.
<7> The electrode active material according to <6>, wherein M² contains Mn.
<8> The electrode active material according to any one of <1> to <7>, wherein the mixed metal oxide in the powder (B) has a layered rock-salt type crystal structure.
<9> The electrode active material according to any one of <1> to <8>, wherein the mixed metal oxide in the powder (B) is represented by the following formula (3):

A¹ₓ₃(Ni_{1-y31-y32}Mn_{y31}Fe_{y32})O₂ (3)

wherein A¹ represents one or more elements selected from the group consisting of Li, Na and K, 0<x₃≦1.5, 0<y₃₁≦1 and 0≦y₃₂1.
<10> The electrode active material according to <6> or <9>, wherein A¹ contains Na.
<11> The electrode active material according to <6> or <9>, wherein A¹ is Na.
<12> The electrode active material according to any one of <1> to <11>, wherein the transition metal lithium phosphate in the powder
(B) is represented by the following formula (4):

Liₓ₄M⁴_{y4}(PO₄)_{z4} (4)

wherein M⁴ represents one or more elements selected from the group consisting transition metal elements, 0<x₄≦1.5, 0<y₄≦3 and 0<z₄3.
<13> The electrode active material according to <12>, wherein M⁴ comprises a divalent transition metal element.
<14> The electrode active material according to <12> or <13>, wherein M⁴ comprises Fe or Mn or both.
<15> An electrode comprising the electrode active material according to any one of <1> to <14>.
<16> A sodium secondary battery comprising the electrode according to <15> as a positive electrode.

### NODE FOR CARRYING OUT THE INVENTION

### <Electrode Active Material>

The electrode active material contains the following powder (A) and powder (B).

The powder (A) is a powder of a transition metal sodium phosphate, the powder having a BET specific surface area of from 1 m²/g to 100 m²/g.

The powder (B) is a powder of a mixed metal oxide or a powder of a transition metal lithium phosphate or both.

From the viewpoint of further improving the effects of the present invention, in the electrode active material, the content of the powder (A), relative to 100 parts by weight of the powder (B), is preferably from 10 parts by weight to 900 parts by weight, more preferably from 30 parts by weight to 800 parts by weight, still more preferably from 50 parts by weight to 700 parts by weight, and particularly preferably from 100 parts by weight to 600 parts by weight.

The electrode active material is obtained by mixing the powder (A) and the powder (B). The mixing of the powder (A) and the powder

(B) may be carried out by either dry mixing or wet mixing. From the viewpoint of convenience, the dry mixing is preferably used. Examples of the mixing device include mortar mixing, a stirrer mixer, a V-type mixer, a W-type mixer, a ribbon mixer, a drum mixer, and a ball mill.

The powder (A) preferably has a BET specific surface area of from 1 m²/g to 100 m²/g, and accordingly, it is possible to increase discharging capacity per weight of the active material. By allowing the electrode active material to contain the powder (A) and the powder (B), it is possible to increase the active material density in the electrode. Consequently, the energy density in a secondary battery is increased so that a sodium secondary battery having high capacity can be obtained.

In the case where the powder (A) has a BET specific surface area of less than 1 m²/g, the discharging capacity of the resultant sodium secondary battery is not sufficient. In the case where the powder (A) has a BET specific surface area of exceeding 100 m²/g, the density of the electrode active material in the electrode is lowered, with the result that the energy density in the secondary battery is also lowered. From the viewpoint of obtaining a sodium secondary battery having increased capacity, the powder (A) preferably has a BET specific surface area of from 5 m²/g to 50 m²/g.

The transition metal sodium phosphate in the powder (A) is preferably represented by the following formula (1). Thus, a sodium secondary battery having higher capacity can be obtained by using a more inexpensive raw material.

Naₓ₁M¹_{y1}(PO₄)_{z1} (1)

wherein M¹ represents one or more elements selected from the group consisting of transition metal elements, 0<x₁≦1.5, 0<y₁≦3 and 0<z₁≦3.

Since the resultant sodium secondary battery tends to have higher discharging capacity, in the formula (1), x₁ is preferably from 0.8 to 1.2, y₁ is preferably from 0.9 to 1.1, and z₁ is preferably from 0.8 to 1.2. More preferably, x₁, y1 and z₁ are respectively 1.

M¹ is one or more elements selected from the group consisting of transition metal elements, and examples of the transition metal elements include Ti, V, Cr, Mn, Fe, Co, Ni, and Cu. From the viewpoint of further increasing the discharging capacity of the resultant sodium secondary battery, M¹ preferably contains a divalent transition metal element. From the viewpoints of easily obtaining a transition metal sodium phosphate having high crystalline purity and of obtaining an inexpensive secondary battery, M¹ preferably contains Fe or Mn or both, and more preferably M¹ is Fe or Mn or both.

Examples of the crystal structure of the transition metal sodium phosphate represented by the formula (1) include crystal structures belonging to space groups selected from P222, P222₁, P2₁2₁2, Pb₁2₁2₁, C222₁, C222, F222, I222, I2₁2₁2₁, Pmm2, Pmc2₁, Pcc2, Pma2, Pca2₁, Pnc2, Pmn2₁, Pba2, Pna2₁, Pnn2, Cmm2, Cmc2₁, Ccc2, Amm2, Abm2, Ama2, Aba2, Fmm2, Fdd2, Imm2, Iba2, Ima2, Pmmm, Pnnn, Pccm, Pban, Pmma, Pnna, Pmna, Pcca, Pbam, Pccn, Pbcm, Pnnm, Pmmn, Pbcn, Pbca, Pnma, Cmcm, Cmca, Cmmm, Cccm, Cmma, Ccca, fmmm, Fddd, Immm, Ibam, Ibca and Imma. From the viewpoint of increasing the capacity of the resultant sodium secondary battery, the transition metal sodium phosphate represented by the formula (1) preferably has an orthorhombic crystal structure, and the crystal structure more preferably belongs to a space group Pnma. Examples of the transition metal sodium phosphates having a crystal structure belonging to the space group Pnma include NaFePO₄ and NaMnPO₄. These crystal structures can be identified by a powder X-ray diffraction measurement using a CuKα ray source.

Within a range not impairing the effects of the present invention, one portion of the sodium in the powder (A) may be substituted with other elements. Examples of the other elements include Li and K.

The electrode active material of the present invention contains the powder (B) in addition to the powder (A).

A mixed metal oxide in the powder (B) is preferably represented by the following formula (2):

A¹ₓ₂M²_{y2}O_{z2} (2)

wherein A¹ represents one or more elements selected from the group consisting of Li, Na and K, M² represents one or more elements selected from the group consisting of transition metal elements, 0<x₂1.5, 0<y₂≦3 and 0<z₂6.

Since the resultant sodium secondary battery tends to have higher discharging capacity, x₂ is preferably from 0.4 to 1.4, and more preferably from 0.6 to 1.2; y₂ is preferably from 0.5 to 2; and z₂ is preferably from 0.8 to 5, and more preferably from 1.8 to 4.

M² is one or more elements selected from the group consisting of transition metal elements, and examples of the transition metal elements include Ti, V, Cr, Mn, Fe, Co, Ni, and Cu. From the viewpoint of further increasing the discharging capacity of the resultant sodium secondary battery, M² preferably contains Fe or Mn or both, and more preferably contains Mn.

The crystal structure of the mixed metal oxide represented by the formula (2) is preferably a spinel-type crystal structure, a perovskite-type crystal structure, or a layer-type crystal structure. The mixed metal oxide more preferably has a hexagonal crystal structure. A preferable structure is a layered rock-salt type crystal structure classified into the space group R-3m. These crystal structures can be identified by a powder X-ray diffraction measurement using a CuKα ray source.

The mixed metal oxide in the powder (B) is more preferably represented by the following formula (3):

A¹ₓ₃(Ni_{1-y31-y32}Mn_{y31}Fe_{y32})O₂ (3)

wherein A¹ represents one or more elements selected from the group consisting of Li, Na and K, 0<x₃≦1.5, 0<y₃₁≦1 and 0<y₃₂≦1.

Since the resultant sodium secondary battery tends to have higher discharging capacity, x₃ is preferably from 0.8 to 1.2, and more preferably 1; y₃₁ is preferably from 0.1 to 0.8, and more preferably from 0.2 to 0.7; and y₃₂ is preferably from 0 to 0.7, and more preferably from 0.01 to 0.5.

A¹ is one or more elements selected from the group consisting of Li, Na and K, and is preferably Li or Na or both. From the viewpoint of further increasing the discharging capacity of the resultant sodium secondary battery, A¹ preferably contains Na, and is more preferably Na.

Since the powder (B) is a powder of the mixed metal oxide, not only the active material density in the electrode can be increased in comparison with a conventional structure, but also the discharging capacity of the secondary battery can be further enhanced.

The powder (B) may be a powder of a transition metal lithium phosphate. The transition metal lithium phosphate in the powder (B) is preferably represented by the following formula (4):

Liₓ₄M⁴_{y4}(PO₄)_{z4} (4)

wherein M⁴ represents one or more elements selected from the group consisting transition metal elements, 0<x₄≦1.5, 0<y₄≦3 and 0<Z₄≦3.

Since the resultant sodium secondary battery tends to have higher discharging capacity, x₄ is preferably from 0.8 to 1.2, y₄ is preferably from 0.9 to 1.1, and z₄ is preferably from 0.8 to 1.2. More preferably, x₄, y₄ and z₄ are respectively 1.

Within a range not impairing the effects of the present invention, one portion of Li in the (4) may be substituted with other elements. Examples of the other elements include Na and K.

M⁴ is one or more elements selected from the group consisting of transition metal elements, and examples of the transition metal elements include Ti, V, Cr, Mn, Fe, Co, Ni, and Cu. From the viewpoint of further increasing the discharging capacity of the resultant sodium secondary battery, M⁴ preferably contains a divalent transition metal element. From the viewpoints of easily obtaining a transition metal lithium phosphate having high crystalline purity, and of also obtaining an inexpensive secondary battery, M⁴ preferably contains Fe or Mn or both, and M⁴ is more preferably Fe or Mn or both.

Since the powder (B) is a powder of the transition metal lithium phosphate, not only the active material density in the electrode can be increased in comparison with a conventional structure, but also the discharging potential of the resultant sodium secondary battery at the time of discharging can be further stabilized, thereby making it possible to increase the average discharging potential.

The powder (B) may contain one or more powders selected from powders of the mixed metal oxides, and one or more powders selected from powders of the transition metal lithium phosphates; and thus, not only the active material density in the electrode can be increased in comparison with a conventional structure, but also the discharging capacity and the average discharging potential can be properly controlled by mixing the respective powders in a well-balanced manner.

When the balance between the discharging capacity and the rate characteristics of the resultant secondary battery is taken into consideration, the powder (B) preferably has a BET specific surface area of from 1 m²/g to 50 m²/g, and more preferably from 1 m²/g to 40 m²/g. From the viewpoint of increasing the active material density in the electrode, the discharging capacity and the energy density of the battery in a well-balanced manner, a value, obtained by dividing the BET specific surface area of the powder (A) by the BET specific surface area of the powder (B), is preferably from 0.2 to 5, and more preferably from 0.5 to 4.

Within a range not impairing the effects of the present invention, one portion of the respective elements in the powder (A) or the powder (B) or both may be substituted with other elements. Examples of the other elements include B, C, N, F, Mg, Al, Si, S, Cl, Ca, Ga, Ge, Rb, Sr, In, Sn, I, and Ba.

Within a range not impairing the effects of the present invention, a compound different from the powder (A) and the powder (B) may be allowed to adhere to the surface of each of particles forming the powder (A) or the powder (B) or both. Examples of the compound include compounds containing one or more elements selected from the group consisting of B, Al, Ga, In, Si, Ge, Sn, Mg, and transition metal elements; preferably include compounds containing one or more elements selected from the group consisting of B, Al, Mg, Ga, In, and Sn; and more preferably include compounds of Al. Specific examples the compound include oxides, hydroxides, oxyhydroxides, carbonates, nitrates, and organic acid salts of the above-mentioned elements, and preferably include oxides, hydroxides, oxyhydroxides of the above-mentioned elements. These compounds may be mixed and used. Among these compounds, a particularly preferable compound is alumina. After the adhesion thereof, heating may be carried out. In the case where the BET specific surface area of a powder after the adhesion and the heating becomes smaller than the BET specific surface area of the powder prior to the adhesion, the specific area prior to the adhesion is used as the BET specific surface area of the powder.

### <Production Method of Powder (A)>

The following description will discuss a method for producing the powder (A), a powder of a transition metal sodium phosphate. The powder of a transition metal sodium phosphate is produced by, for example, the following method. Respective compounds containing respective elements that can form a target transition metal sodium phosphate are weighed respectively so as to have prescribed compositions, and respective aqueous solutions in which the respective compounds thus weighted have been dissolved are manufactured, and by bringing the respective aqueous solutions into contact with each other to generate a precipitate, a powder of the target transition metal sodium phosphate can be produced.

For example, in the case where M¹ is Fe, sodium iron phosphate, represented by NaFePO₄ that is one of preferable compositions, can be obtained through processes in which sodium hydroxide, a ferric chloride (II) tetrahydrate and diammonium hydrogenphosphate are precisely weighed so as to have a molar ratio of Na:Fe:P of 3:1:1, and the respective compounds thus precisely weighed are then dissolved in ion-exchange water so that respective aqueous solutions are prepared, and the respective aqueous solutions are brought into contact with each other to generate a precipitate, and the precipitate is solid-liquid separated.

For example, in the case where M¹ is Mn, sodium manganese phosphate, represented by NaMnPO₄ that is one of preferable compositions, can be obtained through processes in which sodium hydroxide, a manganese chloride (II) hexahydrate and diammonium hydrogenphosphate are precisely weighed so as to have a molar ratio of Na:Mn:P of 4:1:1, and the respective compounds thus precisely weighed are then dissolved in ion-exchange water so that respective aqueous solutions are prepared, and the respective aqueous solutions are brought into contact with each other to generate a precipitate, and the precipitate is solid-liquid separated by heating.

For example, sodium manganese iron phosphate, represented by NaMn_{y11}Fe_{1-y11}PO₄, can be obtained through processes in which sodium hydroxide, a manganese chloride (II) hexahydrate, a ferric chloride (II) tetrahydrate and diammonium hydrogenphosphate are precisely weighed so as to have a molar ratio of Na:Mn:Fe:P of 4:y₁₁:(1−y₁₁):1, and the respective compounds thus precisely weighed are then dissolved in ion-exchange water so that respective aqueous solutions are prepared, and the respective aqueous solutions are brought into contact with each other to generate a precipitate, and the precipitate is solid-liquid separated by heating.

As the compounds containing the respective elements Na, M¹ (M¹ has the same meaning as defined earlier) and P, compounds that are decomposed and/or oxidized at a high temperature to be formed into oxides or compounds that are dissolved in water to be formed into an aqueous solution can be used such as oxides, hydroxides, oxyhydroxides, carbonates, sulfates, nitrates, acetates, halides, ammonium salt, oxalates, phosphates and alkoxides. Metal materials may be used as raw materials. In the case where the compound or material that is hardly dissolved in water is used, for example, in the case where metal materials, oxides, hydroxides, oxyhydroxides, carbonates, or the like are used, these may be dissolved in an aqueous solution containing hydrochloric acid, sulfuric acid, nitric acid, acetic acid, phosphoric acid or the like, so that an aqueous solution thereof may be produced. As a compound containing Na, preferably, a hydroxide or a carbonate or both may be used; as a compound containing M¹, preferably, a chloride or a nitrate or both may be used; and as a compound containing P, preferably, phosphoric acid or an ammonium salt or both may be used. A mixed compound containing two or more of the above-mentioned elements may also be used.

In order to stabilize M¹ such as Fe or Mn as a divalent group in the aqueous solution, the aqueous solution preferably contains a reducer. Examples of the reducer include ascorbic acid, oxalic acid, tin chloride, potassium iodide, sulfur dioxide, hydrogen peroxide, and aniline, and preferably ascorbic acid or aniline, and more preferably ascorbic acid.

The solid-liquid separation of the precipitate obtained by bringing the respective aqueous solutions into contact with each other can be carried out by, for example, removing water using a method such as filtration, centrifugation and heating. The solid material obtained by the solid-liquid separation may be washed. The solvent to be used for the washing is not particularly limited. The solvent is preferably water, and more preferably pure water or ion-exchange water. After having been washed with pure water and/or ion-exchange water, the solid material is dried so that a powder of a transition metal sodium phosphate can be obtained. The drying temperature is preferably from 20° C. to 200° C. The atmosphere at the time of drying is not particularly limited, and air, oxygen, nitrogen, argon, or a mixed gas thereof may be used. An inert gas atmosphere or a reducing atmosphere, which contains no oxygen, is preferably used. The drying may be carried out under reduced pressure. The washing and the drying may be repeatedly carried out two or more times, and calcination may be carried out after the drying.

The resultant powder of a transition metal sodium phosphate may be subjected to pulverization, classification, and the like by using a ball mill, a vibratory mill, a jet mill, or the like, so as to adjust the particle size thereof. The pulverization and the calcination may be repeatedly carried out two or more times, and the resultant powder of a transition metal sodium phosphate may be washed or classified, if necessary. In some cases, the powder of a transition metal sodium phosphate may be obtained by calcining the precipitate.

<Production method of powder (B)-Mixed metal oxide>

The following description will discuss a method for producing the powder (B), a powder of a mixed metal oxide. The powder of a mixed metal oxide can be produced by calcining a raw material containing constituent metal elements at prescribed ratios. The raw material may be a mixture of the respective compounds containing the respective constituent metal elements, or a mixed compound containing a plurality of metal elements may be used. Examples of the compounds of metal elements include oxides of the metal elements, and compounds that are decomposed and/or oxidized at a high temperature to be formed into oxides, such as hydroxides, oxyhydroxides, carbonates, sulfates, nitrates, acetates, halides, oxalates, and alkoxides of metal elements.

The raw material may contain a reaction accelerator. Specific examples of the reaction accelerator include chlorides such as NaCl, KCl and NH₄Cl; fluorides such as LiF, NaF, KF and HN₄F; boron oxide; and boric acid. The reaction accelerator is preferably the chlorides, and more preferably KCl. Normally, in the case of the same calcination temperature, as the content of the reaction accelerator in the raw material becomes higher, the BET specific surface area tends to become smaller, while the diameter of primary particles and the average diameter of aggregated particles tend to become larger. Two or more kinds of reaction accelerators may be used in combination. The reaction accelerator may be left in the powder of a mixed metal oxide, or may be removed therefrom by washing after calcination, evaporation during calcination, or the like.

The calcination temperature upon producing the powder (B), a powder of a mixed metal oxide, is preferably from 600° C. to 1100° C., and more preferably from 650° C. to 900° C. The period of time during which the calcining is retained at the temperature is normally from 0.1 to 20 hours, and preferably from 0.5 to 8 hours. The temperature rising rate up to the calcination temperature is normally from 50 to 400° C./hour, and the temperature lowering rate from the calcination temperature to room temperature is normally from 10 to 400° C. /hour. As the calcination atmosphere, atmospheric air, oxygen, nitrogen, argon or a mixed gas thereof may be used, and preferably atmospheric air is used.

The powder of a mixed metal oxide after the calcination may be pulverized by using a ball mill, a jet mill, or the like. The pulverization and the calcination may be repeated two or more times, and the powder may be washed or classified, if necessary.

In the case of producing a preferable mixed metal oxide represented by the formula (3) as the powder (B), the powder of a mixed metal oxide, for example, Na(Ni_{1-y31-y32}Mn_{y31}Fe_{y32})O₂ can be produced through processes in which a mixture, adjusted to contain a sodium compound, a nickel compound, a manganese compound and an iron compound so as to have a molar ratio of Na:Ni:Mn:Fe of 1:(1:1−y₃₁−y₃₂):y₃₁:y₃₂, is calcined. An example of the sodium compound includes sodium hydroxide, an example of the nickel compound includes nickel hydroxide, an example of the manganese compound includes manganese dioxide, and an example of the iron compound includes diiron trioxide. The calcination temperature is, for example, from 600° C. to 1000° C.

### <Production Method of Powder (B)-Transition Metal Lithium Phosphate>

The following description will discuss a method for producing a powder of a transition metal lithium phosphate in the powder (b). The powder of a transition metal lithium phosphate can be produced by calcining a raw material containing constituent metal elements and P at prescribed ratios in an inert gas atmosphere at a temperature range of from 400° C. to 900° C. for 5 to 50 hours. In the case where the calcination temperature is less than 400° C., the raw material or the decomposed product thereof may be left in some cases. On the other hand, in the case where the calcination temperature is higher than 900° C., a transition metal lithium phosphate having a single phase crystal structure may be sometimes hardly obtained.

Compounds having metal elements forming the raw material and the P compound are not particularly limited. As the raw materials, those that have high purity as raw materials and are inexpensive are preferably used. Carbonates, hydroxides and organic acid salts are preferably used. Nitrates, chlorides, phosphates and the like may also be used.

### <Electrode: Positive Electrode>

The electrode of the present invention contains the electrode active material of the present invention. The electrode of the present invention is effectively used as an electrode for a sodium secondary battery, and in particular, the electrode of the present invention is preferably used as a positive electrode for a sodium secondary battery.

The positive electrode of the present invention is produced by supporting an electrode mixture containing the electrode active material of the present invention, a binder and a conductive agent, if necessary, onto an electrode current collector.

As the conductive agent, a carbonaceous material may be used, and examples of the carbonaceous material include a graphite powder, carbon black (for example, Ketjen Black (product name, manufactured by Ketjen Black International) and acetylene black), and fiber-state carbonaceous materials. Carbon black and acetylene black are in the form of fine particles with a large surface area. When a small amount of carbon black is added to the electrode mixture, the conductivity inside the electrode becomes higher so that the charging/discharging efficiency and output properties of a secondary battery are improved. However, in the case where too much of carbon black is added to the electrode mixture, the bonding property of the binder, which is exerted between the electrode mixture and the electrode current collector, is lowered, resulting in an increase in resistance inside the electrode. The ratio of the conductive agent in the electrode mixture is normally from 5 parts by weight to 30 parts by weight relative to 100 parts by weight of the electrode active material. When the conductive agent is a fiber-state carbonaceous material, this ratio can be lowered.

From the viewpoint of improving the conductivity of the electrode, the conductive agent may preferably contain a fiber-state carbonaceous material in some cases. Supposing that the length of the fiber-state carbonaceous material is 1, and that the diameter of a cross section of the material perpendicular to the length direction is m, the value of 1/m is normally from 20 to 1000. Supposing that the length of the fiber-state carbonaceous material is 1, and that the average particle diameter (D50) on a volume basis of primary particles and aggregated particles of the primary particles is n in the electrode active material of the present invention, the value of 1/n is normally from 2 to 100, and more preferably from 2 to 50. In the case where 1/n is less than 2, the conductivity between the particles in the electrode active material may become insufficient in some cases, while in the case where 1/n exceeds 100, the bonding property between the electrode mixture and the electrode current collector may be lowered in some cases. It is preferable that the electric conductivity of the fiber-state carbonaceous material be higher. The electric conductivity of the fiber-state carbonaceous material is measured by using a sample prepared by molding the fiber-state carbonaceous material so as to have a density of from 1.0 to 1.5 g/cm³. The electric conductivity of the fiber-state carbonaceous material is normally 1 S/cm or more, and preferably 2 S/cm or more.

Specific examples of the fiber-state carbonaceous material include graphitized carbon fibers and carbon nanotubes. Either single-wall carbon nanotubes or multi-wall carbon nanotubes may be used as the carbon nanotubes. With respect to the fiber-state carbonaceous materials, those commercially available may be pulverized so as to be adjusted within the above-mentioned ranges of 1/m and 1/n. The pulverization may be either dry pulverization or wet pulverization, and examples of the dry pulverization apparatus include a ball mill, a rocking mill and a planetary ball mill, and examples of the wet pulverization apparatus include a ball mill and a disperser. Examples of the disperser include a Dispermat (product name, manufactured by Eko Instruments Co., Ltd.).

In the case of using a fiber-state carbonaceous material, the content of the fiber-state carbonaceous material is preferably from 0.1 parts by weight to 30 parts by weight relative to 100 parts by weight of the powder of the positive electrode active material, from the viewpoint of improving the conductivity of the electrode. As the conductive agent, a carbonaceous material other than the fiber-state carbonaceous material (graphite powder, carbon black, etc.) may be used in combination. The carbonaceous material other than the fiber-state carbonaceous material is preferably formed into a spherical fine particle. In the case of using a carbonaceous material other than the fiber-state carbonaceous material in combination, the content of the material is preferably from 0.1 parts by weight to 30 parts by weight relative to 100 parts by weight of the positive electrode active material.

Examples of the binder include thermoplastic resins, and specific examples of the thermoplastic resin include fluorine resins such as polyvinylidene fluoride (hereinafter, may be sometimes referred to as PVdF), polytetrafluoroethylene (hereinafter, may be sometimes referred to as PTFE), tetrafluoroethylene-hexafluoropropylene-vinylidene fluoride copolymers, hexafluoropropylene-vinylidene fluoride copolymers, and tetrafluoroethylene-perfluorovinyl ether copolymers; and polyolefin resins such as polyethylene and polypropylene. Two or more kinds of these may be mixed with each other and used. A fluorine resin and a polyolefin resin may be used as the binder, and by allowing the electrode mixture to contain these resins so as to have a ratio of the fluorine resin from 1 to 10% by weight as well as a ratio of the polyolefin resin from 0.1 to 2% by weight relative to the electrode mixture, an electrode mixture having a superior bonding property to the electrode can be obtained.

Examples of the electrode current collector include Al, Ni, and stainless steel, and Al is preferably used from the viewpoints of being easily processed into a thin film and of low costs.

Examples of a method of supporting the electrode mixture on the electrode current collector include a pressure molding method and a method in which an electrode mixture paste is obtained by further using an organic solvent or the like, and then the paste is applied to the electrode current collector, followed by drying, and the resultant sheet is pressed so that the electrode mixture is anchored to the current collector. The paste contains the electrode active material, the conductive agent, the binder and an organic solvent. Examples of the organic solvent include amine-based solvents such as N,N-dimethylaminopropylamine and diethylenetriamine, ether-based solvents such as tetrahydrofuran, ketone-based solvents such as methylethyl ketone, ester-based solvents such as methyl acetate, and amide-based solvents such as dimethyl acetoamide and N-methyl-2-pyrrolidone.

Examples of a method of applying the electrode mixture paste onto the electrode current collector include a slit-die coating method, a screen coating method, a curtain coating method, a knife coating method, a gravure coating method, and an electrostatic spraying method. Accordingly, an electrode can be produced.

### <Sodium Secondary Battery>

The following description will discuss a sodium secondary battery having the electrode of the present invention as its positive electrode.

The sodium secondary battery of the present invention has the electrode of the present invention as its positive electrode. The sodium secondary battery is produced through processes in which an electrode group obtained by stacking or stacking and winding a positive electrode, a separator, a negative electrode and a separator in this order, is housed in a battery case such as a battery can, and an electrolytic solution containing an electrolyte and being comprised of an organic solvent is injected into the case.

Examples of the shape of the electrode group include shapes having a cross section such as a circular shape, an elliptical shape, a rectangular shape or a rectangular shape with round corners, when the electrode group was cut in the direction perpendicular to the axis of winding of the electrode group. Examples of the shape of the battery include a paper shape, a coin shape, a cylinder shape, and a rectangular shape.

### <Negative Electrode for Sodium Secondary Battery>

The negative electrode may be doped and dedoped with sodium ions at a potential lower than that of the positive electrode. Examples of the negative electrode include an electrode formed by supporting a negative electrode mixture containing a negative electrode material on a negative electrode current collector, or an electrode comprised of solely a negative electrode material. Examples of the negative electrode material include materials which can be doped and dedoped with sodium ions at a potential lower than that of the positive electrode, among materials selected from a carbonaceous material, a chalcogen compound (such as an oxide or a sulfide), a nitride, metal and an alloy. These negative electrode materials may be mixed and used.

The negative electrode material is exemplified by the following materials. Specific examples of the carbonaceous material include graphites such natural graphite and artificial graphite, cokes, carbon black, thermally decomposable carbons, carbon fibers, and sintered polymeric materials. Specific examples of the oxide include oxides of silicon represented by the formula SiOₓ (wherein x is a positive real number) such as SiO₂ and SiO; oxides of titanium represented by the formula TiOₓ (wherein x is a positive real number) such as TiO₂ and TiO; oxides of vanadium represented by the formula VOₓ (wherein x is a positive real number) such as V₂O₅ and VO₂; oxides of iron represented by the formula FeOₓ (wherein x is a positive real number) such as Fe₃O₄, Fe₂O₃ and FeO; oxides of tin represented by the formula SnOₓ (wherein x is a positive real number) such as SnO₂ and SnO; oxides of tungsten represented by the general formula WOₓ (wherein x is a positive real number) such as WO₃ and WO₂. Specific examples of the sulfide include sulfides of titanium represented by the formula TiSₓ (wherein x is a positive real number) such as Ti₂S₃, TiS₂ and TiS; sulfides of vanadium represented by the formula VSₓ (wherein x is a positive real number) such as V₃5₄, VS₂ and VS; sulfides of iron represented by the formula FeSₓ (wherein x is a positive real number) such as Fe₃S₄, FeS₂ and FeS; sulfides of molybdenum represented by the formula MoSₓ (wherein x is a positive real number) such as Mo₂S₃ and MoS₂; sulfides of tin represented by the formula SnSₓ (wherein x is a positive real number) such as SnS₂ and SnS; sulfides of tungsten represented by the formula WSₓ (wherein x is a positive real number) such as WS₂; sulfides of antimony represented by the formula SbSₓ (wherein x is a positive real number) such as Sb₂S₃; and sulfides of selenium represented by the formula SeSₓ (wherein x is a positive real number) such as Se₅S₃, SeS₂ and SeS. Specific examples of the nitride include sodium-containing nitrides such as NaN₃. Two or more kinds of these carbonaceous materials, oxides, sulfides and nitrides may be used in combination. These materials may be crystalline or amorphous. Each of these carbonaceous materials, oxides, sulfides and nitrides is mainly supported on a negative electrode current collector, and the resultant is used as an electrode.

Specific examples of the metal include sodium metal, silicon metal and tin metal. Specific examples of the alloy include sodium alloys such as Na—Al, Na—Ni and Na—Si; silicon alloys such as Si—Zn; tin alloys such as Sn—Mn, Sn—Co, Sn—Ni, Sn—Cu and Sn—La; and other alloys such as Cu₂Sb and La₃Ni₂Sn₇. Each of these metals and alloys has an oxidizing/reducing potential lower than that of the positive electrode. Each of these metals and alloys is mainly used solely as an electrode (for example, as a foil).

Examples of the shape of the carbonaceous material include a flaky shape such as natural graphite, a spherical shape such as meso-carbon microbeads, a fiber shape such as graphitized carbon fibers, and an aggregate of fine powders.

The negative electrode mixture may contain a binder, if necessary. Examples of the binder include thermoplastic resins. Specific examples of the thermoplastic resin include PVdF, thermoplastic polyimide, carboxymethyl cellulose, polyethylene, and polypropylene. In the case where the electrolytic solution contains no ethylene carbonate to be described later, if a negative electrode mixture containing polyethylene carbonate is used, the resultant battery may have improved cycling characteristics and large-current discharging characteristics in some cases.

Examples of the negative electrode current collector include Cu, Ni, and stainless steel, and from the viewpoints of hardly forming an alloy with sodium and of being easily processed into a thin film, Cu is preferably used. Examples of a method of supporting the negative electrode mixture onto the negative electrode current collector include, as described earlier, a pressure molding method; and a method in which a negative electrode mixture paste is obtained by further using a solvent or the like, and then the paste is applied to the negative electrode current collector, followed by drying, and the resultant sheet is pressed so that the negative electrode mixture is anchored to the current collector.

### <Separator for Non-aqueous Secondary Battery>

Examples of the separator include members having modes such as a porous film, a nonwoven cloth, and a woven cloth, which are made from materials such as polyolefin resins including polyethylene and polypropylene, fluorine resins, and nitrogen-containing aromatic copolymers. The separator may be made from two or more kinds of the above-mentioned materials, or may be a laminate separator which has the above-mentioned members laminated to each other. Examples of the separator include those separators disclosed in, for example, JP2000-30686A and JP10-324758A. From the viewpoint of increasing the volume energy density of the battery with a reduction in inner resistance, the thickness of the separator is normally from about 5 to 200 μm, and preferably from about 5 to 40 μm. The separator is preferably made as thin as possible, as long as its mechanical strength is retained. From the viewpoint of improving the ion permeability in the second battery, the separator is preferably provided with a gas permeability measured by a Gurley method of from 50 to 300 seconds/100 cc, and more preferably from 50 to 200 seconds/100 cc. The rate of porosity of the separator is normally from 30 to 80% by volume, and more preferably from 40 to 70% by volume. The separator may have a laminate structure in which separators having different porosities are laminated.

The separator preferably includes a porous film containing a thermoplastic resin. In the secondary battery, the separator is disposed between the positive electrode and the negative electrode. The separator is preferably designed to have such a function that, when an abnormal current flows in a battery due to a short circuit or the like between positive and negative electrodes, it interrupts the current to prevent (shutdown) an excessive current from flowing therethrough. In this case, the shutdown is carried out by clogging the fine pores of the porous film in the separator when the temperature exceeds the normally used temperature. The separator is also preferably designed such that even when, after the fine pores of the separator are clogged, the temperature inside the battery rises to a certain degree of high temperature, the state of the fine pores of the separator being clogged is preferably maintained without the separator being film-ruptured by the temperature. Examples of the separator include a laminate film which has a heat resistant porous layer and a porous film laminated to each other. By using the film as a separator, the heat resistant property of the secondary battery is further improved. The heat resistant porous layers may be laminated to both surfaces of the porous film.

### <Separator for Non-aqueous Electrolyte Secondary Battery: Laminate Film>

The following description will discuss the laminate film which has the heat resistant porous layer and the porous film laminated to each other.

In the laminate film, the heat resistant porous layer is a layer having a heat resistant property higher than that of the porous film, and the heat resistant porous layer may be formed from an inorganic powder, or may contain a heat resistant resin. By allowing the heat resistant porous layer to contain a heat resistant resin, it is possible to form a heat resistant porous layer by using an easy procedure such as coating. Examples of the heat resistant resin include polyamide, polyimide, polyamideimide, polycarbonate, polyacetal, polysulfone, polyphenylene sulfide, polyetherketone, aromatic polyester, polyether sulfone and polyether imide. The heat resistant resin is preferably polyamide, polyimide, polyamideimide, polyether sulfone, or polyether imide, more preferably polyamide, polyimide or polyamideimide, and still further preferably a nitrogen-containing aromatic polymer such as an aromatic polyamide (para-oriented aromatic polyamide, meta-oriented aromatic polyamide), an aromatic polyimide, or an aromatic polyamideimide, and especially preferably an aromatic polyamide. From the viewpoint of easiness in use, the heat resistant resin is, in particular, preferably a para-oriented aromatic polyamide (hereinafter, may be sometimes referred to as “para-aramide”). Examples of the heat resistant resin also include poly-4-methylpentene-1 and cyclic olefin-based polymers. By using these heat resistant resins, the heat resistant property of the laminate film, that is, the thermal film-rupturing temperature of the laminate film can be improved. In the case where, among these heat resistant resins, the nitrogen-containing aromatic polymer is used, good compatibility with an electrolytic solution may be sometimes exerted because of the polarity inside its molecule, and in such a case, the liquid-retaining property of the electrolytic solution in the heat resistant porous layer is improved. Thus, upon production of a secondary battery, the injecting rate of the electrolytic solution becomes faster, and the charging/discharging capacity of the secondary battery is also increased.

The thermal film-rupturing temperature of the laminate film depends on the kind of the heat resistant resin, and is selected and used in accordance with the application state and application purpose. More specifically, in the case where the nitrogen-containing aromatic polymer is used as the heat resistant resin, the thermal film-rupturing temperature can be controlled to about 400° C., in the case where poly-4-methylpentene-1 is used, it can be controlled to about 250° C., and in the case where a cyclic olefin-based polymer is used, it can be controlled to about 300° C., respectively. In the case where the heat resistant porous layer is made from an inorganic powder, the thermal film-rupturing temperature can be controlled to, for example, 500° C. or more.

The para-amide can be obtained by condensation polymerization between a para-oriented aromatic diamine and a para-oriented aromatic dicarboxylic acid halide, and its amide bonds are virtually composed of repeating units bonded at the para position or corresponding oriented position of an aromatic ring (for example, an oriented position extending coaxially in the opposite direction or in parallel therewith, such as 4,4′-biphenylene, 1,5-naphthalene, and 2,6-naphthalene). Specific examples thereof include para-aramides having a para-oriented structure or a structure corresponding to the para-oriented type such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6 naphthalene dicarboxylic acid amide), poly(2-chloro-paraphenylene terephthalamide), and paraphenylene terephthalamide/2,6-dichloroparaphenylene terephthalamide copolymers.

The aromatic polyimide is preferably a total aromatic polyimide produced by condensation polymerization between an aromatic dianhydride and a diamine. Specific examples of the dianhydride include pyromellitic dianhydride, 3,3′,4,4′-diphenylsulfonetetracarboxylic dianhydride, 3,3′,4,4′-benzophenonetetracarboxylic dianhydride, 2,2′-bis(3,4-dicarboxyphenyl)hexafluoropropane and 3,3′,4,4′-biphenyltetracarboxylic dianhydride. Specific examples of the diamine include oxydianiline, paraphenylene diamine, benzophenone diamine, 3,3′-methylene dianiline, 3,3′-diaminobenzophenone, 3,3′-diaminodiphenyl sulfone and 1,5-naphthalene diamine. Moreover, a polyimide that is soluble to a solvent is desirably used. Examples of the polyimide include a polyimide of a polycondensation product between 3,3′,4,4′-diphenylsulfonetetracarboxylic dianhydride and an aromatic diamine.

Examples of the aromatic polyamideimide include a condensation polymerization product between an aromatic dicarboxylic acid and an aromatic diisocyanate, and a condensation polymerization product between an aromatic dianhydride and an aromatic diisocyanate. Specific examples of the aromatic dicarboxylic acid include isophthalic acid and terephthalic acid. Specific examples of the aromatic dianhydride include trimellitic anhydride. Specific examples of the aromatic diisocyanate include 4,4′-diphenylmethane diisocyanate, 2,4-tolylene diisocyanate, 2,6-tolylene diisocyanate, ortho-tolylene diisocyanate, and m-xylene diisocyanate.

From the viewpoint of improving the ion permeability, the thickness of the heat resistant porous layer is preferably made thinner, and specifically, it is preferably from 1 μm to 10 μm, more preferably from 1 μm to 5 μm, and particularly preferably from 1 μm to 4 μm. The heat resistant porous layer has fine pores, and the size (diameter) of each pore is normally 3 μm or less, and preferably 1 μm or less.

In the case where the heat resistant porous layer contains a heat resistant resin, the heat resistant porous layer may contain a filler. Examples of the material for the filler include an organic powder, an inorganic powder and a mixture thereof. Particles forming the filler preferably have an average particle diameter of from 0.01 μm to 1 μm.

Examples of the organic powder include powders made from organic substances such as a single material or a copolymer of two or more kinds of materials including styrene, vinyl ketone, acrylonitrile, methylmethacrylate, ethylmethacrylate, glycidyl methacrylate, glycidyl acrylate and methylacrylate; fluorine resins such as polytetrafluoroethylene, a tetrafluoroethylene-hexafluoropropylene copolymer, a tetrafluoroethylene-ethylene copolymer, and polyvinylidene fluoride; melamine resins; urea resins; polyolefins; and polymethacrylates. Each of these organic powders may be used solely, or two or more kinds thereof may be mixed and used. Among these organic powders, from the viewpoint of chemical stability, a polytetrafluoroethylene powder is preferably used.

Examples of the inorganic powder include powders made from inorganic substances such as metal oxides, metal nitrides, metal carbides, metal hydroxides, carbonates, and sulfates. Among these, powders made from inorganic substances having low conductivity are preferably used. Specific examples of the inorganic powder preferably include powders made from one or more compounds selected from the group consisting of alumina, silica, titanium dioxide and calcium carbonate. Each of these inorganic powders may be used solely, or two or more kinds thereof may be mixed and used. Among these inorganic powders, from the viewpoint of chemical stability, an alumina powder is preferably used. More preferably, all the particles forming the alumina powder are composed of alumina particles, and furthermore preferably, all the particles forming the filler are alumina particles, with a portion or all of the alumina particles being formed into virtually spherical shapes. In the case where the heat resistant porous layer is made from inorganic powder, the above-exemplified inorganic powder may be used, and may also be mixed with a binder, if necessary, and used.

In the case where the heat resistant porous layer contains a heat resistant resin, the content of the filler is dependent on the specific gravity of the filler material. For example, when all the particles forming the filler are made of alumina particles, the weight ratio of the filler is normally from 5 to 95, preferably from 20 to 95, and more preferably from 30 to 90 relative to total weight 100 of the heat-resistant porous layer. These ranges can be appropriately determined depending on the specific gravity of the filler material.

Examples of the filler shape include a virtually spherical shape, a plate shape, a pillar shape, a needle shape, a whisker shape, and a fiber shape, and from the viewpoint of easily forming uniform pores, a virtually spherical shape is preferable. Examples of the virtually spherical particles include particles having an aspect ratio (major axis of particles/minor axis of particles) of particles of from 1 to 1.5. The aspect ratio of the particles can be measured by using an electron microscope photograph.

The porous film in the laminate film has fine pores. The porous film is preferably provided with a shut down function, and in this case, it contains a thermoplastic resin. The size (diameter) of each fine pore of the porous film is normally 3 μm or less, and preferably 1 μm or less. The rate of porosity of the porous film is normally from 30 to 80% by volume, and preferably from 40 to 70% by volume. In the case where a secondary battery is used at a temperature exceeding the normally used temperature, the separator is allowed to exert the shut down function of the porous film, that is, to clog the fine pores by softening the thermoplastic resin forming the porous film.

As the resin forming the porous film in the laminate film, those resins that are insoluble to the electrolytic solution are selected. Specific examples of the resin include polyolefin resins such as polyethylene and polypropylene, and a thermoplastic polyurethane resin, and two or more kinds of the thermoplastic resins may be mixed and used. From the viewpoint of being softened at a lower temperature to cause a shut down, the porous film preferably contains a polyolefin resin, and more preferably contains polyethylene. Specific examples of the polyethylene include a low-density polyethylene, a high-density polyethylene and a linear polyethylene, and an ultra-high molecular weight polyethylene having a molecular weight of 1,000,000 or more. From the viewpoint of further increasing the sticking-resistant strength of the porous film, the porous film preferably contains an ultra-high molecular weight polyethylene. In order to easily produce the porous film, the thermoplastic resin may be preferably allowed to contain a wax made from polyolefin having a low molecular weight (weight average molecular weight of 10,000 or less) in some cases.

The thickness of the porous film in the laminate film is normally from 3 to 30 μm, preferably from 3 to 25 μm, and more preferably from 3 to 19 μm. The thickness of the laminate film is normally 40 μm or less, preferably 30 μm or less, and more preferably 20 μm or less. Supposing that the thickness of the heat resistant porous layer is A (μm), and that the thickness of the porous film is B (μm), the value of A/B is preferably from 0.1 to 1.

### <Electrolytic Solution or Solid-state Electrolyte for Sodium Secondary Battery>

An electrolytic solution normally contains an electrolyte and an organic solvent. Examples of the electrolyte include sodium salts such as NaClO₄, NaPF₆, NaAsF₆, NaSbF₆, NaBF₄, NaCF₃SO₃, NaN(SO₂CF₃)₂, NaN(SO₂C₂F₅)₂, NaN(SO₂CF₃) (COCF₃), Na(C₄F₉SO₃), NaC(SO₂CF₃)_{3 NaBPh}₄, Na₂B₁₀Cl₁₀, NaBOB (in this case, BOB represents bis(oxalato)borate), sodium salts of lower aliphatic carboxylic acid and NaAlCl₄, and two or more kinds of these electrolytes may be mixed and used. Among these, one or more fluorine-containing sodium salts selected from the group consisting of NaPF₆, NaAsF₆, NaSbF₆, NaBF₄, NaCF₃SO₃, NaN(SO₂CF₃)₂ and NaC(SO₂CF₃)₃ are preferably used.

Examples of the organic solvent in the electrolytic solution include carbonates such as propylene carbonate (hereinafter, may be sometimes referred to as PC), ethylene carbonate, dimethyl carbonate, diethyl carbonate, vinylene carbonate, isopropylmethyl carbonate, propylmethyl carbonate, ethylmethyl carbonate, 4-trifluoromethyl-1,3-dioxolan-2-one and 1,2-di(methoxycarbonyloxy)ethane; ethers such as 1,2-dimethoxyethane, 1,3-dimethoxypropane, pentafluoropropyl methylether, 2,2,3,3-tetrafluoropropyl difluoromethylether, tetrahydrofuran and 2-methyl tetrahydrofuran; esters such as methyl formate, methyl acetate and y-butyrolactone; nitriles such as acetonitrile and butyronitrile; amides such as N,N-dimethylformamide and N,N-dimethylacetoamide; carbamates such as 3-methyl-2-oxazolidone; sulfur-containing compounds such as sulforan, dimethylsulfoxide and 1,3-propane sultone, and those solvents formed by further introducing a fluorine substituent to the above-mentioned organic solvents. A mixed solvent which contains two or more kinds of these solvents may be used.

In place of the electrolytic solution, a solid-state electrolyte may be used. As the solid-state electrolyte, for example, organic solid-state electrolytes such as a polyethylene oxide-based polymer or a polymer containing at least one kind of a polyorgano siloxane chain and a polyoxyalkylene chain may be used.

A so-called gel-type electrolyte formed by allowing a polymer to support an electrolytic solution may also be used. A sulfur compound-based solid-state electrolyte such as Na₂S—SiS₂, Na₂S—GeS₂, Na₂S—P₂S₂, Na₂S—B₂S₃, Na₂S—SiS_{2—Na}₃PO₄ or Na₂S—SiS₂—Na₂SO₄; and an inorganic solid-state electrolyte, for example, a NASICON-type electrolyte such as NaZr₂(PO₄)₃ may also be used. By using these solid-state electrolytes, high safety may be further ensured. In the sodium secondary battery, in the case of using the solid-state electrolyte, the solid-state electrolyte may serve as a separator in some cases, and in this case, no separator may be required in some cases.

### EXAMPLES

The following description will further discuss the present invention in detail by means of examples. The evaluation method of a powder (A) and a powder (B), the manufacture method of an electrode and a secondary battery and the evaluation method of the secondary battery are described as follows.

### (1) Manufacture of Electrode

A material prepared by mixing acetylene black and graphite at a ratio of 9:1 (weight ratio) was used as a conductive material. As a binder solution, a solution prepared by dissolving PVdF (PolyVinylideneDiFluoridePolyflon, manufactured by Kureha Corporation) in NMP (manufactured by Tokyo Chemical Industry Co., Ltd.) was used. An electrode active material and the conductive material were mixed so as to have composition of electrode active material:conductive agent:binder of 87:10:3 (weight ratio), and the binder solution was added to this, and these were kneaded so that an electrode mixture paste was obtained. The paste was applied to an Al foil having a thickness of 40 μm serving as a current collector, and this was dried at 60° C. for 2 hours so that an electrode sheet was obtained. Next, the electrode sheet was rolled at a pressure of 0.5 MPa by using a press roller, and this was punched out by a punching machine into a size of 14.5 mm φ, and then vacuum-dried at 150° C. for 8 hours so that an electrodes were obtained.

### (2) Manufacture of Secondary Battery

The electrode obtained in (1) was used as a positive electrode.

As a separator, a polypropylene porous film (thickness: 20 μm) was used. As a solvent for an electrolytic solution, PC was used. As an electrolyte, NaClO₄ was used. The electrolyte was dissolved in the mixed solvent at a rate of 1 mole/liter so that an electrolytic solution 1 was prepared. As a negative electrode, metal sodium was used. The positive electrode was placed on a concave portion of the lower part of a coin cell (manufactured by Hohsen Corporation) with its aluminum foil surface facing down, and the separator was placed thereon, and then the electrolytic solution 1 was injected thereto. Next, the negative electrode and a middle lid were combined with each other and these were placed on the upper side of the separator with the negative electrode facing down, and the upper part was put thereon as a lid with a gasket interpolated therebetween, and the lid was caulked by using a caulking machine, so that a sodium secondary battery (coin-shaped battery P2032) was manufactured. The assembling processes of the battery were carried out in a glove box in an argon atmosphere.

### (3) Evaluation of Secondary Battery

Charging/discharging tests were carried on the secondary battery while being kept at 25° C., under the following conditions.

### <Charging/Discharging Tests>

Discharging was carried out while the discharging rate in each cycle was changed in the following manner, with the charging maximum voltage being set to 4.2 V and the discharging minimum voltage being set to 1.5 V.

Discharging at 1^{st} and 2^{nd} cycles: 0.1 C

Discharging at 3^{rd} and 4^{th} cycles: 1 C

Discharging at 5^{th} cycle: 5 C

### <Discharging Capacity Retaining Rate>

Discharging capacity retaining rate (%)=(discharging capacity at 5^{th} cycle (5 C))/(initial discharging capacity (discharging capacity at 1^{st} cycle (0.1 C))×100

### (4) Evaluation of Powder (A) and Powder (B)

### 1. Measurements of BET Specific Surface Area

After drying 1 g of a powder in a nitrogen atmosphere at 150° C. for 15 minutes, the BET specific surface area of the powder was measured using a Flowsorb 112300 manufactured by Micrometrics Instruments Corporation.

### 2. Powder X-ray Diffraction Measurements

Powder X-ray diffraction measurements were carried out on the powder by using RINT 2500 TTR manufactured by Rigaku Corporation. The measurements were carried out by using a CuKα ray within a diffraction angle 2θ of 10 to 90° so that a powder X-ray diffraction pattern was obtained.

Production Example 1 (Powder (A): Production of powder of transition metal sodium phosphate)

Sodium hydroxide (NaOH) serving as a source of Na, a ferric chloride (II) tetrahydrate (FeCl₂·4H₂O) serving as a source of Fe and phosphoric acid (H₃PO₄) serving as a source of P were precisely weighed so as to have a molar ratio of sodium (Na):iron (Fe):phosphorus (P) of 3:1:1, and the respective compounds thus precisely weighed were put into glass beakers of 100 ml, and ion-exchange water was added to the beakers so that respective aqueous solutions were obtained. Next, the aqueous sodium hydroxide solution and the aqueous phosphoric acid solution were mixed with each other while being stirred, and to this was further added an aqueous solution in which ferric chloride (II) tetrahydrate had been dissolved so that a liquid-like material was obtained. The resultant liquid-like material was put into an egg plant flask, and then the egg plant flask was heated for 20 minutes in an oil bath set at 150° C. so that a precipitate was obtained. This precipitate was washed with water, and filtered so that a solid-state component was obtained, and the solid-state component was dried at 100° C. for 3 hours so that a powder S₁ was obtained.

When the powder S₁ was subjected to a powder X-ray diffraction measurement, it was found that the powder S₁ was a single-phase sodium iron phosphate. The powder S₁ had a BET specific surface area of 20 m²/g.

### Production Example 2-1 (Powder (B): Production of Powder of Lithium Mixed Metal Oxide)

To 200 ml of distilled water in a beaker made of polypropylene was added 83.88 g of potassium hydroxide, and the potassium hydroxide was dissolved by stirring so that an aqueous potassium hydroxide solution (aqueous alkali solution) was prepared. To 200 ml of distilled water in a beaker made of glass were added 16.04 g of a nickel chloride (II) hexahydrate, 13.36 g of a manganese chloride (II) tetrahydrate and 2.982 g of a ferric chloride (II) tetrahydrate, and these were dissolved by stirring so that an aqueous nickel-manganese-iron mixed solution was obtained. While stirring an aqueous potassium hydroxide solution, the aqueous nickel-manganese-iron mixed solution was added dropwise to this solution so that a coprecipitation slurry containing a coprecipitation product generated was obtained.

Next, the coprecipitation slurry was filtrated, and washed with distilled water, and the resultant solid-state component was dried at 100° C. so that the coprecipitation product was obtained. Then, 2.0 g of the coprecipitation product, 1.16 g of a lithium hydroxide monohydrate and 1.16 g of KCl were dry-mixed with each other by using an agate mortar so that a mixture was obtained. The mixture was put in a calcination container made of alumina, and this was kept in an electric furnace at 800° C. in the atmospheric air for 6 hours so as to be calcined, and this was cooled to room temperature; thus, a calcined product was obtained. The calcined product was pulverized and washed with distilled water by using decantation, and filtrated so that a solid-state component was obtained. The resultant solid-state component was dried at 100° C. for 8 hours; thus, a powder L₁ was obtained.

The powder L₁ had a BET specific surface area of 7.8 m²/g. As a result of powder X-ray diffraction measurements carried out on the powder L₁, it was found that the lithium mixed metal oxide in the powder L₁ had a layered rock-salt type crystal structure classified into the R-3m space group, and the powder L₁ was represented by the formula (3).

### Production Example 2-2 (Powder (B): Production of Powder of Sodium Mixed Metal Oxide)

To 200 ml of distilled water in a beaker made of polypropylene was added 83.88 g of potassium hydroxide, and the potassium hydroxide was dissolved by stirring so that an aqueous potassium hydroxide solution (aqueous alkali solution) was prepared. To 200 ml of distilled water in a beaker made of glass were added 16.04 g of a nickel chloride (II) hexahydrate, 13.36 g of a manganese chloride (II) tetrahydrate and 2.982 g of a ferric chloride (II) tetrahydrate, and these were dissolved by stirring so that an aqueous nickel-manganese-iron mixed solution was obtained. While stirring an aqueous potassium hydroxide solution, the aqueous nickel-manganese-iron mixed solution was added dropwise to this solution so that a coprecipitation slurry containing a coprecipitation product generated was obtained.

Next, the coprecipitation slurry was filtrated, and washed with distilled water, and the resultant solid-state component was dried at 100° C. so that the coprecipitation product was obtained. Then, 2.0 g of the coprecipitation product and 2.92 g of sodium carbonate were dry-mixed with each other so that a mixture was obtained. The mixture was put in a calcination container made of alumina, and this was kept in an electric furnace at 850° C. in the atmospheric air for 10 hours so as to be calcined, and this was cooled to room temperature; thus, a calcined product was obtained. The calcined product was pulverized so that a powder N₁ was obtained.

The powder N₁ had a BET specific surface area of 5.5 m²/g. As a result of powder X-ray diffraction measurements carried out on the powder N₁, it was found that the sodium mixed metal oxide in the powder N₁ had a layered rock-salt type crystal structure classified into the R-3m space group, and the powder N₁ was represented by the formula (3).

### Production Example 3 (Powder (B): Production of Powder of Transition Metal Lithium Phosphate)

A lithium hydroxide monohydrate, iron oxalate and ammonium hydrogenphosphate were precisely weighed so as to have a molar ratio of Li:Fe:P of 1:1:1, and mixed with each other so that a mixture was prepared. The mixture was calcined at 800° C. in a nitrogen-gas atmosphere for 10 hours so that a powder S₂ was obtained.

As a result of powder X-ray diffraction measurements carried out on the powder S₂, it was found that the transition metal lithium phosphate in the powder S₂ was a single-phase lithium iron phosphate. The powder S₂ had a BET specific surface area of 6.1 m²/g.

### Production Example 4 (Comparison)

Sodium carbonate (Na₂CO₃), an iron oxalate dihydrate (FeC₂O₄·2H₂O) and diammonium hydrogenphosphate ((NH₄)₂HPO₄) were precisely weighed so as to have a molar ratio of sodium (Na):iron (Fe):phosphorus (P) of 1:1:1, and mixed in an agate mortar over 20 minutes so that a mixture was obtained. The resultant mixture was temporarily calcined at 450° C. over 10 hours in a nitrogen gas atmosphere.

The resultant sample that had been calcined was pulverized in an agate mortar over 20 minutes. The resultant pulverized product was calcined at 800° C. over 24 hours in a nitrogen gas atmosphere. The resultant calcined product was further pulverized by a ball mill so that a powder R₁ was obtained.

As a result of powder X-ray diffraction measurements carried out on the powder R₁, it was found that the powder R₁ was a single-phase sodium iron phosphate. The powder R₁ had a BET specific surface area of 0.67 m²/g.

### Comparative Example 1

By using the powder R₁ in Production Example 4, the aforementioned processes were carried out so that a sodium secondary battery was manufactured. When the charging/discharging tests were carried out on the secondary battery, it was found that a discharging capacity at 0.1 C was 65 mAh/g, which was a low level, and when the discharging capacity retaining rate was measured, the resultant value was 57%, which was a low level.

### Example 1

The powder S₁ (2 g) in Production Example 1 and the powder L₁ (2 g) in Production Example 2-1 were precisely weighed respectively (100 parts by weight of S₁ relative to 100 parts by weight of L₁), and these were sufficiently mixed in an agate mortar so that an electrode active material was obtained. By using this, the aforementioned processes were carried out so that a sodium secondary battery was manufactured. When the charging/discharging tests were carried out on the secondary battery, respective values of the discharging capacity and the discharging capacity retaining rate of the secondary battery were greater than those values of Comparative Example 1; thus, this secondary battery was found to be superior in both the discharging capacity and the rate characteristics.

### Example 2

The powder S₁ (4 g) in Production Example 1 and the powder N₁ (2 g) in Production Example 2-2 were precisely weighed respectively (200 parts by weight of S₁ relative to 100 parts by weight of N₁), and these were sufficiently mixed in an agate mortar so that an electrode active material was obtained. By using this, the aforementioned processes were carried out so that a sodium secondary battery was manufactured. When the charging/discharging tests were carried out on the secondary battery, respective values of the discharging capacity and the discharging capacity retaining rate of the secondary battery were greater than those values of Comparative Example 1; thus, this secondary battery was found to be superior in both the discharging capacity and the rate characteristics.

### Example 3

The powder S₁ (12 g) in Production Example 1 and the powder S₂ (2 g) in Production Example 3 were precisely weighed respectively (600 parts by weight of S₁ relative to 100 parts by weight of S₂), and these were sufficiently mixed in an agate mortar so that an electrode active material was obtained. By using this, the aforementioned processes were carried out so that a sodium secondary battery was manufactured. When the charging/discharging tests were carried out on the secondary battery, respective values of the discharging capacity and the discharging capacity retaining rate of the secondary battery were greater than those values of Comparative Example 1; thus, this secondary battery was found to be superior in both the discharging capacity and the rate characteristics.

### Production Example 5 (Production of Laminate Film)

### (1) Production of Coating Solution

After 272.7 g of calcium chloride had been dissolved in 4200 g of NMP, to this was added 132.9 g of paraphenylene diamine and completely dissolved therein. To the resultant solution was gradually added 243.3 g of terephthaloyl dichloride to be polymerized so that para-aramide was obtained, and this was further diluted with NMP so that a para-aramide solution (A) having a concentration of 2.0% by weight was obtained. To the resultant para-aramide solution (100 g) were added 2 g of an alumina powder (a)(alumina C, manufactured by Japan Aerosil Inc., average particle diameter: 0.02 μm) and 2 g of an alumina powder (b) (Sumicorundum AA03, manufactured by Sumitomo Chemical Co., Ltd., average particle diameter: 0.3 μm), that is, the total of 4 g, and mixed therein as fillers, and this was processed by a nanomizer three times, and further filtered by a wire gauze with 1000 meshes, and then defoamed under reduced pressure so that a slurry coating solution (B) was produced. The weight of the alumina powder (filler) relative to the total weight of the paraamide and the alumina powder was 67% by weight.

### (2) Production and Evaluations of Laminate Film

As a porous film, a polyethylene porous film (film thickness: 12 μm, gas permeability: 140 seconds/100 cc, average pore diameter: 0.1 μm, rate of porosity: 50%) was used. The polyethylene porous film was secured onto a PET film having a thickness of 100 μm, and the slurry coating solution (B) was applied onto the porous film by using a bar coater manufactured by Tester Sangyo Co., Ltd. The PET film and the applied porous film were immersed into water as a poor solvent while being integrally kept so that a para-aramide porous film (heat resistant layer) was deposited thereon, and the solvent was then dried so that a laminate film 1 having the heat resistant porous layer and the porous film stacked thereon was obtained. The laminate film 1 had a thickness of 16 μm, and the paraamide porous film (heat resistant porous layer) had a thickness of 4 μm. The laminate film 1 had a gas permeability of 180 seconds/100 cc, and a rate of porosity of 50%. When the cross section of the heat resistant porous layer in the laminate film 1 was observed by a scanning electron microscope (SEM), it was found that comparatively small fine pores in a range from about 0.03 μm to 0.06 μm and comparatively large fine pores in a range from about 0.1 μm to 1 μm were present. The evaluations on the laminate film were carried out by the following method.

### <Evaluation of Laminate Film>

### (A) Thickness Measurements

The thickness of the laminate film and the thickness of the porous film were measured in accordance with JIS Standard (K7130-1992). Moreover, a value obtained by subtracting the thickness of the porous film from the thickness of the laminate film was used as the thickness of the heat resistant porous layer.

### (B) Measurements of Gas Permeability by Gurley Method

The gas permeability of the laminate film was measured in accordance with JIS P8117 by using a digital timer-type Gurley type Densometer manufactured by Yasuda Seiki Seisakusho Ltd.

### (C) Rate of Porosity

The sample of the resultant laminate film was cut out into a square having a length of 10 cm in each side, and the weight W (g) and the thickness D (cm) were measured. The weights of the respective layers in the sample (Wi(g); i is an integer from 1 to n) were obtained, and based on Wi and the true specific gravity (true specific gravity i (g/cm³)) of the material of each layer, the volume of each of the layers was obtained, and the rate of porosity (% by volume) was calculated from the following expression:

Rate of porosity (% by volume)=100×{1−(W1/True Specific Gravity 1+W2/True Specific Gravity 2+ . . . +Wn/True Specific Gravity n)/(10×10×D)}

In the examples, by using the laminate film obtained from Production Example 5, a sodium secondary battery capable of increasing the thermal film-rupturing temperature can be obtained.

### INDUSTRIAL APPLICABILITY

The present invention makes it possible to provide an electrode active material that can produce a secondary battery having high capacity. Since sodium abundant in resources is utilized, it becomes possible to produce a large-number of large-sized secondary batteries, such as secondary batteries for use in automobiles and secondary batteries for use in dispersion-type power storages; therefore, the present invention is very useful from the industrial point of view.

1. An electrode active material comprising the following powder (A) and powder (B):
(A) a powder of a transition metal sodium phosphate, the powder having a BET specific surface area of from 1 m²/g to 100 m²/g,
(B) a powder of a mixed metal oxide or a powder of a transition metal lithium phosphate or both.

2. The electrode active material according to claim 1, wherein the content of the powder (A) is from 10 parts by weight to 900 parts by weight relative to 100 parts by weight of the powder (B).

3. The electrode active material according to claim 1, wherein the transition metal sodium phosphate in the powder (A) is represented by the following formula (1):
Naₓ₁M¹_{y1} (PO₄)_{z1} (1)
wherein M¹ represents one or more elements selected from the group consisting of transition metal elements, 0<x₁≦1.5, 0y₁≦3 and 0<z₁≦3.

4. The electrode active material according to claim 3, wherein M¹ comprises a divalent transition metal element.

5. The electrode active material according to claim 3, wherein M¹ comprises Fe or Mn or both.

6. The electrode active material according to Claim 1, wherein the mixed metal oxide in the powder (B) is represented by the following formula (2):
A¹ₓ₂M²_{y2}O_{z2} (2)
wherein A¹ represents one or more elements selected from the group consisting of Li, Na and K, M² represents one or more elements selected from the group consisting of transition metal elements, 0<x₂≦1.5, 0<y₂≦3 and 0<z₂≦6.

7. The electrode active material according to claim 6, wherein M² contains Mn.

8. The electrode active material according to Claim 1, wherein the mixed metal oxide in the powder (B) has a layered rock-salt type crystal structure.

9. The electrode active material according to Claim 1, wherein the mixed metal oxide in the powder (B) is represented by the following formula (3):
A¹ₓ₃(Ni_{1-y31-y32}Mn_{y31}Fe_{y32})O₂ (3)
wherein A¹ represents one or more elements selected from the group consisting of Li, Na and K, 0<x₃≦1.5, 0<y₃₁≦1 and 0y₃₂≦1.

10. The electrode active material according to claim 6, wherein A¹ contains Na.

11. The electrode active material according to claim 6, wherein A¹ is Na.

12. The electrode active material according to Claim 1, wherein the transition metal lithium phosphate in the powder (B) is represented by the following formula (4):
Liₓ₄M⁴_{y4}(PO₄)_{z4} (4)
wherein M⁴ represents one or more elements selected from the group consisting of transition metal elements, 0<x₄≦1.5, 0<y₄≦3 and 0<z₄≦3.

13. The electrode active material according to claim 12, wherein M⁴ comprises a divalent transition metal element.

14. The electrode active material according to claim 12, wherein M⁴ comprises Fe or Mn or both.

15. An electrode comprising the electrode active material according to.

16. A sodium secondary battery comprising the electrode according to claim 15 as a positive electrode.
